(19) United States
(12) Patent Application Publication
(10) Pub. No.: US 2017/0286949 A1
(43) Pub. Date: Oct. 5, 2017

(54) METHODS AND SYSTEMS FOR PERFORMING A TRANSACTION

(71) Applicant: MasterCard International Incorporated, Purchase, NY (US)

(72) Inventors: Arunmurthy Gurunathan, Vishrantwadi (IN); Ravi Pareek, Nagar (IN); Sachin Shrivastava, Nagar (IN)

(21) Appl. No.: 15/471,556

(22) Filed: Mar. 28, 2017

(30) Foreign Application Priority Data
Mar. 29, 2016 (SG) 10201602458P

(51) Int. Cl. G06Q 20/36; G06Q 20/40; G06Q 20/32; G06Q 20/14

(52) U.S. Cl. CPC G06Q 20/36; G06Q 20/14; G06Q 20/405; G06Q 20/3226; G06Q 20/407

(57) ABSTRACT

A computerised method for performing a transaction is disclosed. The method comprises: generating, by a merchant billing machine at a merchant location, transaction data comprising a transaction cost and identifying, via the merchant billing machine, a customer digital wallet and/or number for a customer mobile device. The merchant billing machine then communicates the transaction data and identification of a merchant digital wallet to the customer digital wallet and/or customer mobile device. A digital wallet server receives, upon authorisation of the transaction via the customer mobile device, the transaction data and merchant digital wallet identification along with details of a customer payment vehicle and transfers the transaction cost from the customer payment vehicle to the merchant digital wallet.

### CROSS-REFERENCE TO RELATED APPLICATION

This application is a U.S. National Stage filing under 35 U.S.C. §119, based on and claiming benefit of and priority to SG Patent Application No. 10201602458P filed Mar. 29, 2016.

### FIELD OF THE INVENTION

The present invention relates to methods and systems for performing a transaction. In particular, the transaction may be performed at a merchant location with funds being transferred from a customer to a merchant digital wallet.

### BACKGROUND OF THE INVENTION

To date, the use of digital wallets has related exclusively to on-line shopping with on-line merchants.

Peer-to-peer payment (P2P payment, also called person-to-person payment) is an online technology that allows a “sender” to transfer funds from a payment account associated with the sender, to a payment account associated with a payment “recipient” via the Internet or a mobile phone. The sender may for example be a customer of a recipient who is a merchant. Typically, neither the sender nor the recipient has to trust the other with information about his or her payment account.

There are two conventional methods for initiating a P2P payment. In the first method, the sender and payee establish secure accounts with a trusted third-party vendor (typically, a financial institution), designating their respective bank account or credit card information to be used to transfer and accept funds. Using the third party's website or a mobile application, the sender and recipient can complete the process of sending or receiving funds. The sender can only send funds to someone who is a member of the network.

In the second method, the sender uses an online interface or mobile application (typically provided by his or her bank or another financial institution) to contact a third party site. To initiate the transfer, the sender indicates the amount of funds to be transferred, and provides contact data for the payee (an email address or phone number). Once the transfer has been initiated by the sender, the recipient receives a notification using the contact data. The recipient uses the online interface or mobile application to input his or her payment account information (e.g. the number of a payment account held by a bank, and details of the bank) to accept the transfer of funds. In this second method, recipients do not need to have a payment account with the same financial institution as the sender in order to receive a money transfer.

While the above systems are adequate for online payments, physical stores typically still require a point-of-sale terminal (POS), near field communication (NFC), Acquirer charges and full time internet to facilitate cashless payment transactions. Such requirements are relatively expensive for small-sized and newly established merchants.

One proposal that may address some of the above concerns requires a merchant to identify itself to the customer by encoding the merchant's account details in the form of a Quick Response (QR) code to be scanned by a customer's mobile device so that the customer can then transfer the required funds to the merchant. Although this system is more secure from the customer's perspective as it does not require the customer to share account details with the merchant, it does require that the merchant account details be passed directly to the customer.

There is therefore a need for improved methods and systems for performing transactions with such merchants.

### SUMMARY OF THE INVENTION

In accordance with a first aspect of the present invention there is provided a computerised method for performing a transaction comprising:

a) generating, by a merchant billing machine at a merchant location, transaction data comprising a transaction cost;
b) identifying, via the merchant billing machine, a customer digital wallet and/or number for a customer mobile device;
c) said merchant billing machine communicating said transaction data and identification of a merchant digital wallet to the customer digital wallet and/or customer mobile device;
d) receiving, by a digital wallet server, upon authorisation of the transaction via the customer mobile device, said transaction data and merchant digital wallet identification along with details of a customer payment vehicle; and
e) transferring, by the digital wallet server, the transaction cost from the customer payment vehicle to the merchant digital wallet.

Embodiments of the present invention therefore provide a computerised method enabling a brick and mortar merchant to utilise wallet services for transactions performed by customers at the merchant location. Use of a billing machine with an integrated wallet payment mechanism will assist small retailers to go cashless (e.g. by use of P2P or wallet to wallet fund transfers) without the additional cost of POS terminals, acquirer fees and internet costs. Consequently, embodiments of the invention can eradicate cash mishandling by labourers along with the risk of holding cash at the merchant location. Furthermore, embodiments of the invention do not require the customer to disclose his/her account details to the merchant to facilitate the transaction.

The step of identifying a customer digital wallet and/or number for a customer mobile device may comprise entering into the merchant billing machine a unique identifier for the customer. The unique identifier may be constituted by a wallet identification code.

The customer may choose to register details comprising identification of the customer digital wallet and/or number for the customer mobile device with a customer database that is accessible by the merchant billing machine. In which case, the step of identifying the customer digital wallet and/or number for the customer mobile device may comprise identifying the customer in the customer database and extracting relevant details for that customer.

The customer database may further comprise biometric data which may be used by the merchant billing machine to identify the customer digital wallet and/or number for the customer mobile device. The biometric data may comprise one or more of the following: facial recognition data; fingerprint data; or retinal scan data. Thus, in some embodiments, the merchant may have apparatus configured to obtain biometric data from the customer. The apparatus may comprise a facial recognition detector; a fingerprint detector; or a retinal scanner. The customer may therefore choose to provide biometric data obtained by a merchant to the customer database for registering therein.

Once a customer has registered biometric data with the customer database, the step of identifying the customer digital wallet and/or number for the customer mobile device may comprise the merchant obtaining biometric data from the customer and using the biometric data to identify the customer in the customer database.

In some embodiments, the billing machine may act as a server and the customer mobile device may act as a client.

As used in this document, the term “payment card” or “payment vehicle” refers to any suitable cashless payment mechanism, such as a credit card, a debit card, a prepaid card, a charge card, a membership card, a promotional card, a frequent flyer card, an identification card, a gift card, and/or any other physical or electronic device that may hold payment account information, such as digital wallets, mobile phones, Smartphones, personal digital assistants (PDAs), key fobs, transponder devices, NFC-enabled devices, tablets and/or computers. Thus, the customer payment vehicle may take the form of a payment card or a digital wallet.

The customer digital wallet may be configured to receive pre-paid funds (e.g. from an owner's bank account). In this way, the owner may select an amount to pay into the digital wallet (e.g. on an ad hoc, daily, weekly, monthly, quarterly or annual basis). It is believed that such a system will carry less risk of unauthorised transactions than if the wallet was linked directly to the owner's bank account or credit card, for example, if the customer's mobile device and/or digital wallet were stolen. However, in some embodiments, the customer digital wallet may be linked to another type of payment mechanism such as a credit card or debit card.

The step of communicating the transaction data and merchant digital wallet identification may comprise the merchant billing machine actively transmitting the information to the customer's mobile device (e.g. using a near-field communication system).

The method may comprise the merchant billing machine transmitting the transaction data and merchant digital wallet identification to a server for further communication to the customer mobile device. Thus, the billing machine may be provided with a communication device (e.g. for GSM or GPRS communication).

The server may be located over a network and accessible via cloud computing.

The method may further comprise the customer installing a transaction application in the customer mobile device, the transaction application being configured to obtain data from the merchant billing machine and/or server and to communicate with the digital wallet server to transfer the transaction cost from the customer payment vehicle to the merchant digital wallet.

The method may comprise the customer storing information in a database accessible by the transaction application. The database may be constituted by the customer database referred to above. The information may comprise one or more of the customer name, telephone number, email address, physical address and details of at least one customer payment vehicle (e.g. credit card, debit card or digital wallet).

The transaction data may comprise a transaction reference code and/or details of the products purchased (e.g. number and description of products purchased, individual cost per product etc.). It should be noted that the term ‘product’ is used throughout to denote not only physical items purchased from retailers but also services. As such the merchant may be constituted by a shop, restaurant, bar, café, beauty salon etc.

The identification of the merchant digital wallet may comprise a mobile number or reference code associated the merchant billing machine and/or merchant digital wallet.

In some embodiments, both the merchant and the customer require digital wallet facilities to complete the transaction. In which case, the digital wallet server could be associated with the merchant digital wallet or the customer digital wallet.

In some the embodiments, the merchant may pre-register with the digital wallet server such that the identification of the merchant digital wallet may comprise providing a registration code.

Step e) may be carried out in the form of a business-as-usual transaction whereby the digital wallet server sends an authorisation request to a payment network via a payment gateway. An acquirer then processes the authorisation request and transmits it to an issuer bank associated with the customer payment vehicle. Once approved by the issuer bank, the payment is transferred to the acquirer for storing in the merchant digital wallet.

The method may comprise sending an electronic receipt to the customer mobile device. The receipt may comprise an itemized bill relating to the transaction. The receipt may be stored in a database for retrieval by the transaction application. The receipt may the transmitted to the customer mobile device by any suitable means (e.g. by way of an email, SMS or XML instructions for display on a webpage accessible by the transaction application). Thus, embodiments of the invention allow for paperless receipts since the relevant details are transferred electronically to the customer mobile device.

The method may further comprise an option for the customer to request, via the customer mobile device, a full or partial refund of the transaction cost (e.g. on returning a purchased product to the merchant). For example, the transaction application may be configured for the customer to identify a product to be returned and to transmit this information to the merchant billing machine along with details of the customer payment vehicle for receipt of a refund. An original transaction reference number may be included in the return request for aid of identification of the original transaction. On authorisation, the merchant billing machine may transmit a refund request to the digital wallet server for the digital wallet server to refund the required amount from the merchant digital wallet to the customer payment vehicle. The merchant billing machine may also generate and transmit an updated receipt to the customer mobile device.

The customer mobile device may be constituted by a smartphone, tablet, PDA, electronic key-fob or laptop.

In accordance with a second aspect of the present invention there is provided a merchant billing machine configured to generate transaction data comprising a transaction cost and to communicate said transaction data and identification of a merchant digital wallet to the customer digital wallet and/or customer mobile device.

Embodiments of this aspect of the invention therefore provide a novel billing machine capable of providing transaction information to a customer mobile device so that funds can be transferred electronically to the merchant digital wallet.

The merchant billing machine may comprise a communication device (e.g. for NFC or GSM or GPRS communication) configured to transmit said transaction data and identification of a merchant digital wallet to the customer digital wallet and/or customer mobile device. Notably, the merchant billing machine may transmit the data directly to the customer mobile device, or may transmit the data to a server for communication with the customer mobile device.

The invention may be expressed as a network of communicating devices (a “computerized network”). It may further be expressed in terms of a software application downloadable into a computer device to facilitate the method. The software application may be a computer program product, which may be stored in non-transitory form on a tangible data-storage device (such as a storage device of a server, or one within a communication device).

### BRIEF DESCRIPTION OF THE DRAWINGS

Embodiments of the invention will now be described for the sake of example only with reference to the following drawings, in which:

FIG. 1 illustrates a computerised method for performing a transaction in accordance with a first embodiment of the invention;

FIG. 2 illustrates a computerised network of electronic devices for performing the method of FIG. 1;

FIG. 3 shows a more detailed flow chart for a computerised method for performing a transaction in accordance with a second embodiment of the invention;

FIG. 4 shows a flow chart for sending an electronic receipt to a customer mobile device in accordance with embodiments of the invention;

FIG. 5 shows a flow chart for requesting a refund for returned purchases in accordance with embodiments of the invention;

FIG. 6 shows a flow chart of a registration and recognition process for the merchant to recognise returning customers, in accordance with embodiments of the invention;

FIG. 7 shows a block diagram of the technical architecture of the servers of FIG. 1; and

FIG. 8 shows a block diagram of the communication devices of FIG. 1.

### DETAILED DESCRIPTION OF CERTAIN EMBODIMENTS

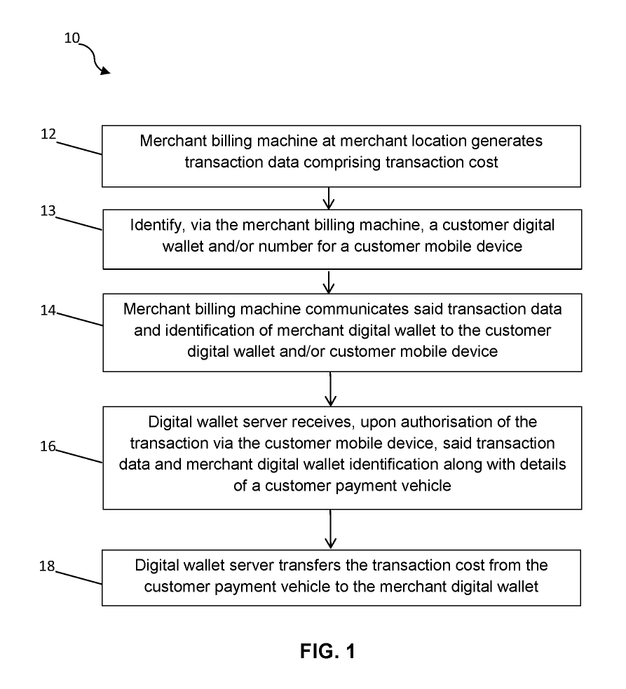

FIG. 1 shows a computerised method 10 for performing a transaction in accordance with a first embodiment of the invention. The method 10 comprises the following steps:

Step 12: generating, by a merchant billing machine at a merchant location, transaction data comprising a transaction cost;

Step 13: identifying, via the merchant billing machine, a customer digital wallet and/or number for a customer mobile device;

Step 14: said merchant billing machine communicating said transaction data and identification of a merchant digital wallet to the customer digital wallet and/or customer mobile device;

Step 16: receiving, by a digital wallet server, upon authorisation of the transaction via the customer mobile device, said transaction data and merchant digital wallet identification along with details of a customer payment vehicle; and

Step 18: transferring, by the digital wallet server, the transaction cost from the customer payment vehicle to the merchant digital wallet.

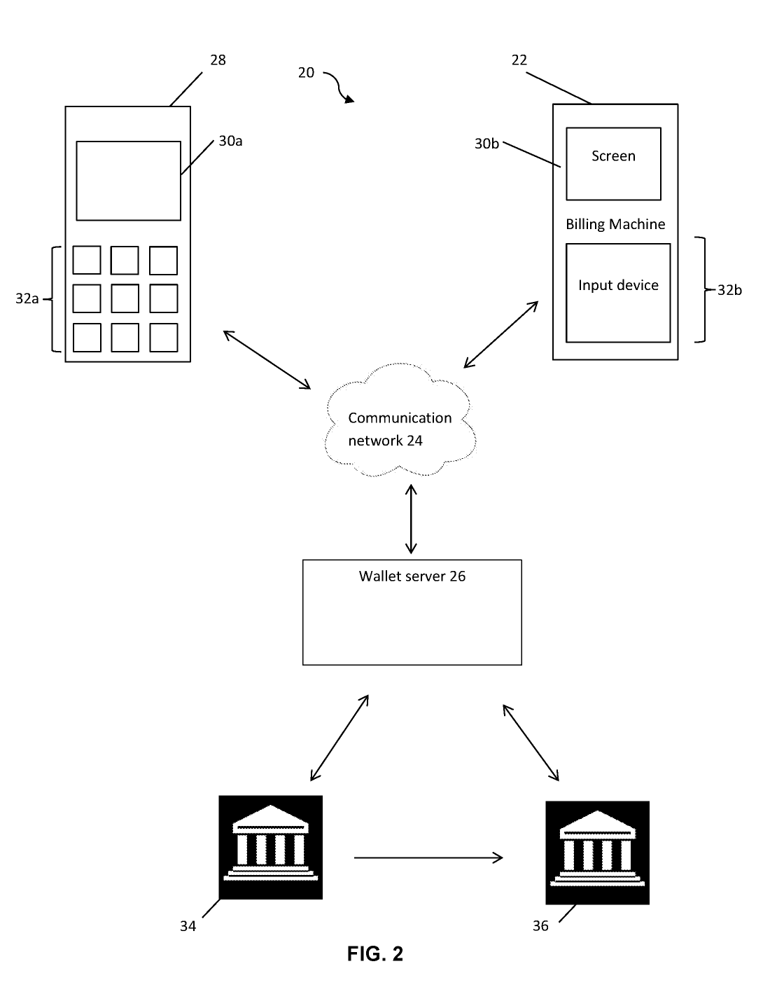

FIG. 2 illustrates a computerised network 20 of electronic devices for performing the method of FIG. 1. Thus, the network 20 comprises a merchant billing machine 22, connected via a communication network 24 to a digital wallet server 26. A customer mobile device 28 is also shown in communication with the communication network 24. The customer mobile device 28 is associated with a person who wishes to make a purchase at a merchant location.

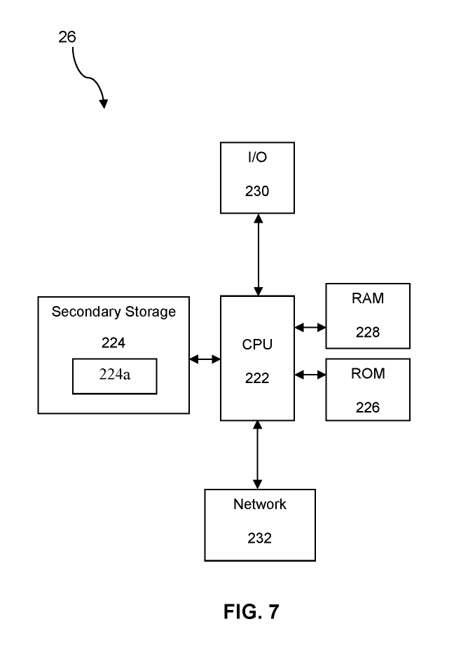

Both the billing machine 22 and the customer mobile device 28 can be considered to be communication devices (which are described below in more detail with reference to FIG. 7). They both include screens 30a, 30b and input devices 32a, 32b. The screens 30a, 30b may be touch sensitive, in which case separate input devices 32a, 32b may not be required and the screens alone may provide a user interface for the device. Both the merchant billing machine 22 and the customer mobile device 28 are able to communicate with the communication network 24 using respective communication interfaces (not shown). The communication devices 22, 28 may communicate with the communication network 24 via a wireless connection (e.g. GPRS, 3G, 4G, WIFI or Bluetooth) or a wired connection.

In FIG. 2, the customer mobile device 28 is depicted as a smartphone, however it may be any mobile electronic communication device, such as a tablet computer or laptop.

The customer associated with the customer mobile device 28 maintains a payment account (e.g. a bank account or a credit card account) at a financial institution (e.g. bank), referred to here as the issuer, and associated with an issuer server 34. The merchant associated with the merchant billing machine 22 maintains a payment account at a financial institution (e.g. bank), referred to here as the acquirer, and associated with an acquirer server 36. The issuer server 34 and acquirer server 36 are controlled by the digital wallet server 26 to make payments between the payment accounts they hold. The communication devices 28, 22 can communicate with the digital wallet server 26 using the communication network 24.

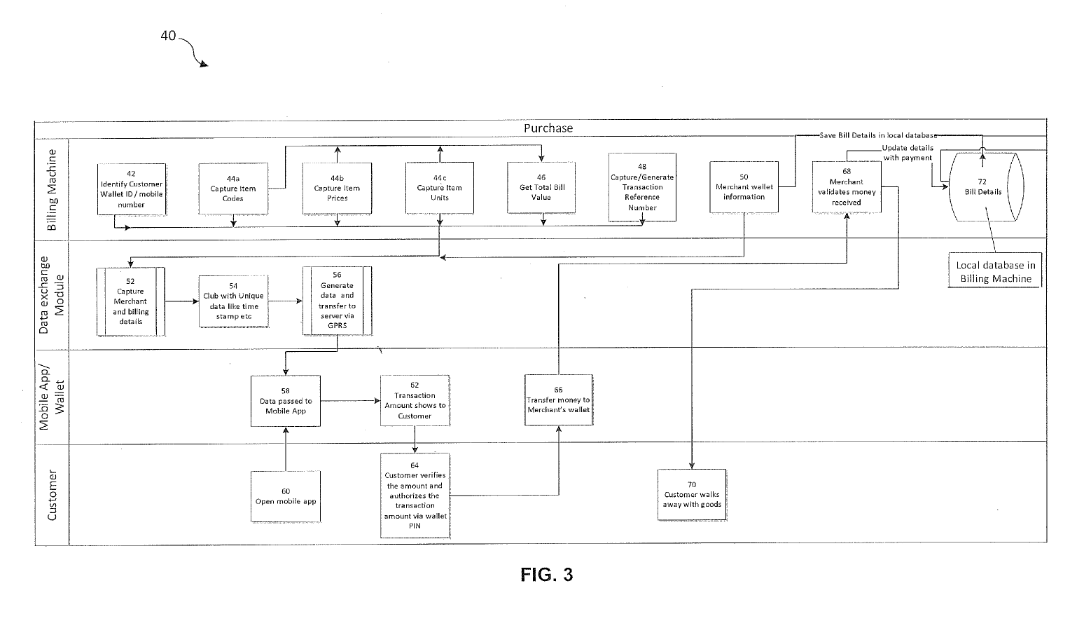

The operation of the components of the network 20 will now be described with reference to the computerised method 40 for performing a transaction in accordance with a second embodiment of the invention, as illustrated in FIG. 3. In this embodiment, the merchant billing machine 22 identifies the number for the customer mobile device 28 in step 42 (e.g. by obtaining biometric data from the customer and using the biometric data to identify a pre-registered customer from a customer database including numbers for each customer's mobile device) and in step 44 collates this with product purchase information (e.g. for products scanned by the merchant billing machine 22 at the point of sale). The product purchase information comprises item codes 44a, item prices 44b, number of item units purchased 44c and a total bill value (i.e. transaction cost) 46. In step 48, the merchant billing machine 22 also captures or generates a transaction reference number. Merchant digital wallet information which is stored in the merchant billing machine 22 is also retrieved (step 50) and relayed with the transaction information detailed above to a data exchange module associated with the merchant billing machine 22 in step 52.

The data exchange module then adds a unique identifier in the form of a timestamp to the data in step 54 before transmitting the data to the digital wallet server 26 via GPRS in step 56. In step 58, the digital wallet server 26 transmits the data to the customer mobile device 28.

The customer then opens a transaction application in step 60 and in step 62, the transaction cost is extracted from the data provided and displayed on the customer mobile device for payment approval. In step 64, the customer authorises the transaction (e.g. by entering a PIN code into the customer mobile device 28). In step 66, the customer mobile device 28 transmits a message to the digital wallet server 26 to proceed with the transaction and provides details of the customer payment vehicle. In this case, the payment is to be made from a customer digital wallet and the details of which are stored in a customer database accessible by the transaction application.

The digital wallet server 26 then proceeds with transferring the transaction cost from the customer payment vehicle (i.e. customer digital wallet) to the merchant digital wallet and in step 68, the merchant billing machine receives a notification from the digital wallet server 26 that the transaction cost has been successfully transferred. The notification may be by any suitable means, for example, by SMS to a mobile number associated with the merchant billing machine 22, by email or by another form of electronic notification. In step 70, the merchant confirms to the customer that payment has been accepted and the customer may take his/her purchased products. In step 72 the merchant billing machine 22 stores details of the transaction/bill in a local database.

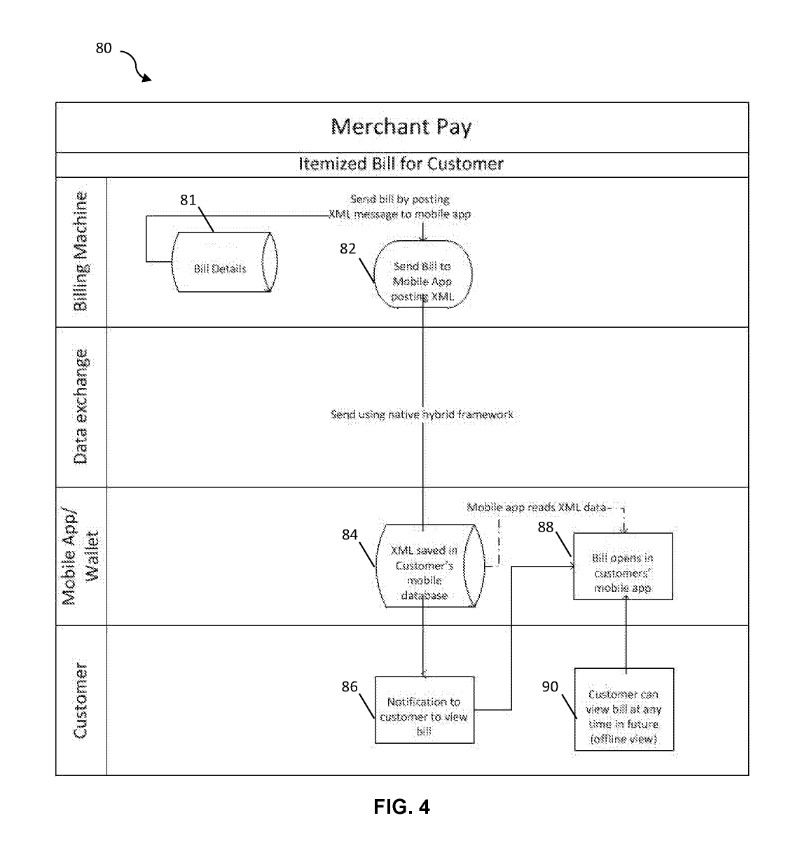

FIG. 4 illustrates a method 80 for sending an electronic receipt to the customer mobile device 28, using the transaction/bill details stored in the database mentioned above, in accordance with embodiments of the invention. In step 81, the merchant billing machine 22 extracts the bill details from the local database and form them into an electronic receipt. In step 82 the merchant billing machine 22 transmits the electronic receipt to the customer mobile device 28 over the communication network 24 (this may be by way of GPRS, 3G, 4G, WIFI or Bluetooth communication). The receipt may be sent in XML format for display by the transaction application. In step 84, the customer mobile device 28 saves the receipt in a local database and in step 86 the transaction application notifies the customer (e.g. by way of a pop-up message displayed on screen 30a) that a receipt has been received can be viewed. In step 88, the transaction application displays the XML receipt for the customer to view. It will also be noted that, in this embodiment, the customer can choose to view the receipt at any future time (step 90) by accessing the receipt through the transaction application, even when offline.

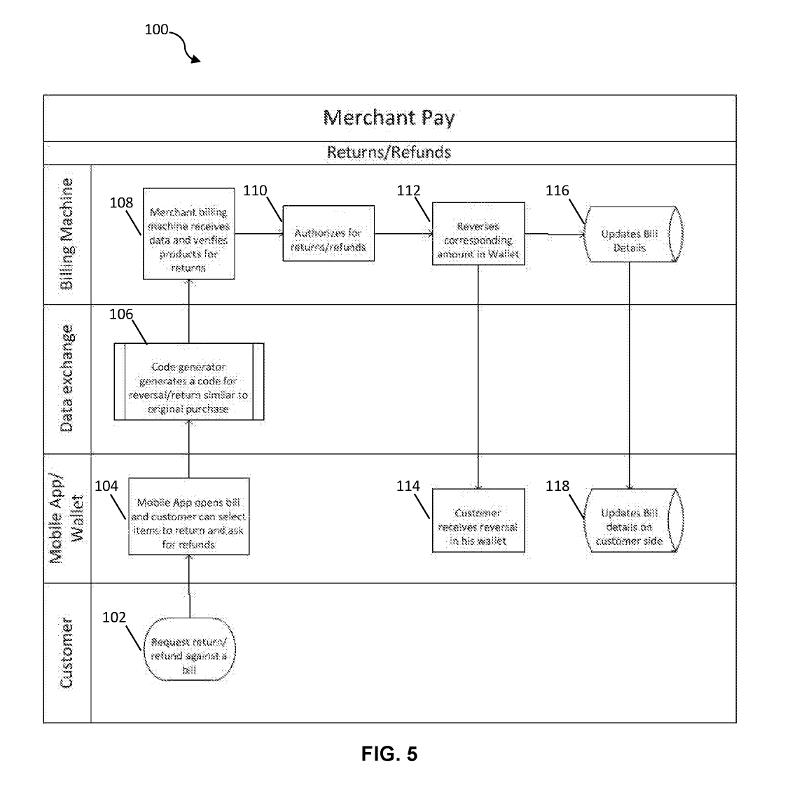

FIG. 5 shows a method 100 for requesting a refund for returned purchases in accordance with embodiments of the invention. In step 102 the customer decides to return an item to the merchant and in step 104 opens the transaction application on the customer mobile device 28 and selects the item (or items) to be returned. The customer mobile device 28 then sends a refund request over the communication network 24 to the merchant billing machine 22 data exchange module, requesting a refund for the items selected. The refund request will include details of the customer payment vehicle for receipt of the returned funds (i.e. identification of the customer digital wallet) as well as details of the original transaction (e.g. transaction reference number) and details of the items to be returned. In step 106 the data exchange module generates a code for the refund transaction and transfers the code along with the refund request data to the merchant billing machine 22 (step 108). The merchant may then authorise the refund (e.g. on receipt of the items being returned) in step 110. In step 112 the merchant billing machine 22 instructs the appropriate funds to be returned to the customer digital wallet. Although not shown, this step will comprise the merchant billing machine 22 transmitting a request to the digital wallet server 26 to refund the appropriate amount from the merchant digital wallet to the customer digital wallet. In step 114, the customer mobile device 28 receives a notification from the digital wallet server 26 that the funds have successfully been transferred to the customer digital wallet (or other payment vehicle). In step 116, the merchant billing machine 22 updates the electronic receipt for the transaction with details of the refund and stores the data in a database. In step 118, the merchant billing machine 22 transfers the updated receipt to the customer mobile device 28 in a similar manner to that described above in relation to FIG. 4.

Embodiments of the present invention may utilise back-end platforms such as API, XML, SQL, SOAP etc. Furthermore, the customer mobile device 28 may communicate with mobile web/clients through JSON API using mobile middleware.

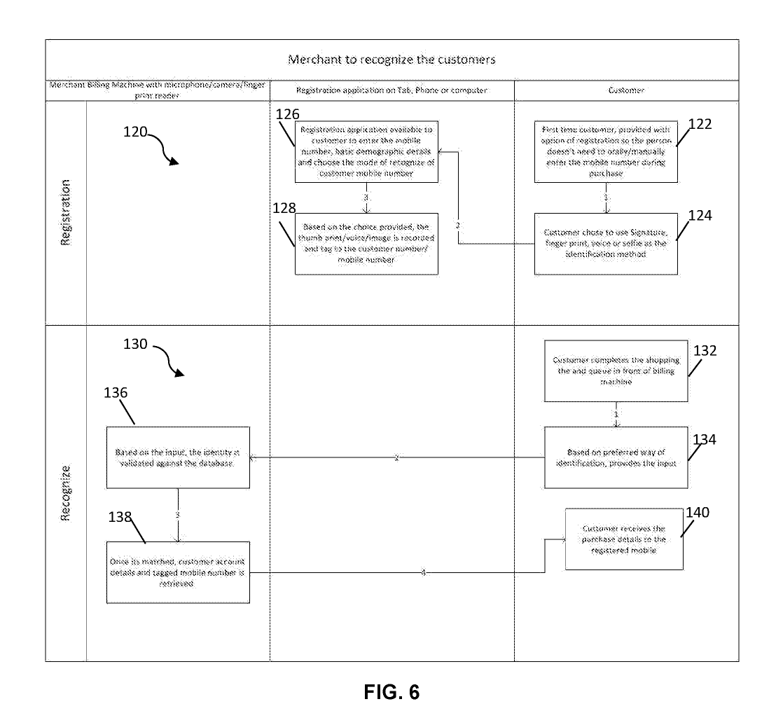

FIG. 6 shows a registration 120 and recognition 130 process for the merchant to recognise returning/pre-registered customers. The registration process 120 comprises the customer being provided with an option in step 122 of registration so that he/she does not need to orally or manually enter his/her mobile telephone number into the merchant billing machine 22 for each purchase made at that merchant or group of merchants. In step 124, the customer may register one or more of a signature, fingerprint, voice recording, retinal image or facial image (e.g. ‘selfie’) as his/her preferred identification method. In step 126, the customer uses a registration application (which may be part of the transaction application referred to above) on a mobile, tablet or other form of computer to register his/her mobile number, demographic details (e.g. name, address, date of birth etc.) and preferred mode or modes of recognition for merchants to identify the customer mobile number from the customer database. Based on the modes selected by the customer, in step 128 the registration application records a signature, fingerprint, voice recording, retinal image or facial image and is stored in the customer database along with customer mobile number and other details provided.

For the recognition process 130, the customer completes his/her shopping at the merchant and queues for payment at the merchant billing machine 22 as normal, in step 132. In step 134, the customer provides input for his/her preferred mode of recognition. This may comprise the customer signing a digital pad, providing a fingerprint, voice recording, retinal or facial image to the merchant billing machine 22. In step 136, the merchant billing machine 22 validates the input received from the customer against the customer database and in step 138 the customer details (including the customer mobile number) are extracted from the customer database if there is a match and customer is recognised from his/her input. The merchant billing machine 22 then sends the transaction details to the customer mobile device in accordance with the process shown in FIG. 3 and in step 138, the customer receives the transaction details through his/her registered mobile device.

FIG. 7 is a block diagram showing a technical architecture of the digital wallet server 26. The issuer server 34 or acquirer server 36 may also have this technical architecture.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

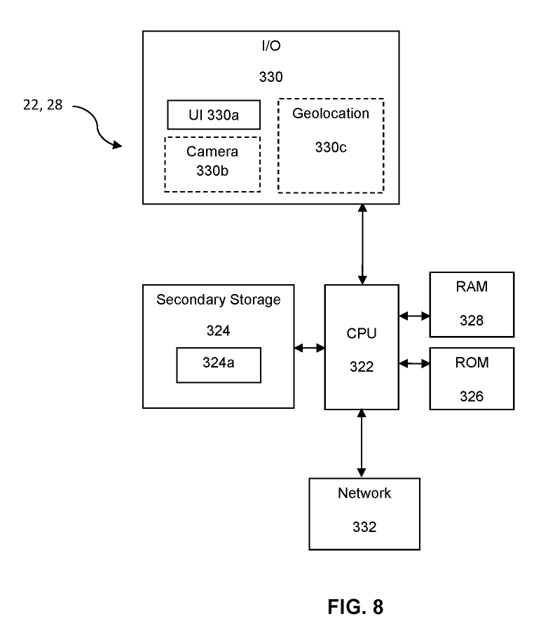

FIG. 8 is a block diagram showing a technical architecture of the customer mobile device 28 and merchant billing machine 22.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a. In the case of the customer mobile device 28, a camera 330b and a geolocation module 330c may also be provided. The UI 330a may comprise a touch screen, keyboard, keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a processing component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiments can be made in accordance with the appended claims.

1. A computerised method for performing a transaction comprising:
a) generating, by a merchant billing machine at a merchant location, transaction data comprising a transaction cost;
b) identifying, via the merchant billing machine, a customer digital wallet and/or number for a customer mobile device;
c) said merchant billing machine communicating said transaction data and identification of a merchant digital wallet to the customer digital wallet and/or customer mobile device;
d) receiving, by a digital wallet server, upon authorisation of the transaction via the customer mobile device, said transaction data and merchant digital wallet identification along with details of a customer payment vehicle; and
e) transferring, by the digital wallet server, the transaction cost from the customer payment vehicle to the merchant digital wallet.

2. The method according to claim 1 wherein the step of identifying the customer digital wallet and/or number for the customer mobile device comprises entering into the merchant billing machine a unique identifier for the customer.

3. The method according to claim 2 wherein the unique identifier is constituted by a wallet identification code.

4. The method according to claim 1 wherein the customer registers details comprising identification of the customer digital wallet and/or number for the customer mobile device with a customer database that is accessible by the merchant billing machine.

5. The method according to claim 4 wherein the step of identifying the customer digital wallet and/or number for the customer mobile device comprise identifying the customer in the customer database and extracting relevant details for that customer.

6. The method according to claim 4 wherein the customer database further comprises biometric data which is used by the merchant billing machine to identify the customer digital wallet and/or number for the customer mobile device.

7. The method according to claim 6 wherein the biometric data comprises one or more of the following: facial recognition data; fingerprint data; or retinal scan data.

8. The method according to claim 6 wherein the step of identifying the customer digital wallet and/or number for the customer mobile device comprises the merchant obtaining biometric data from the customer and using the biometric data to identify the customer in the customer database.

9. The method according to claim 1 wherein the billing machine actively transmits the transaction data and identification of the merchant digital wallet to the customer mobile device.

10. The method according to claim 1 wherein the billing machine transmits the transaction data and merchant digital wallet identification to a server for further communication to the customer mobile device.

11. The method according to claim 1 wherein the merchant billing machine is provided with a communication device.

12. The method according to claim 10 further comprising the customer installing a transaction application in the customer mobile device, the transaction application being configured to obtain data from the merchant billing machine and/or server and to communicate with the digital wallet server to transfer the transaction cost from the customer payment vehicle to the merchant digital wallet.

13. The method according to claim 12 further comprising the customer storing information in a database accessible by the transaction application.

14. The method according to claim 13 wherein the information comprises one or more of the customer name, telephone number, email address, physical address and details of at least one customer payment vehicle.

15. The method according to claim 1 wherein the transaction data comprises a transaction reference code and/or details of the products purchased.

16. The method according to claim 1 wherein the identification of the merchant digital wallet comprises a mobile number or reference code associated the merchant billing machine and/or merchant digital wallet.

17. The method according to claim 1 further comprising sending an electronic receipt to the customer mobile device.

18. The method according to claim 17 wherein the receipt comprises an itemized bill relating to the transaction.

19. The method according to claim 17, wherein the receipt is stored in a database for retrieval by the transaction application.

20. The method according to claim 12 further comprising an option for the customer to request, via the customer mobile device, a full or partial refund of the transaction cost.

21. The method according to claim 20, wherein the transaction application is configured for the customer to identify a product to be returned and to transmit this information to the merchant billing machine along with details of the customer payment vehicle for receipt of a refund.

22. The method according to claim 21 wherein, on authorization, the merchant billing machine transmits a refund request to the digital wallet server for the digital wallet server to refund the required amount from the merchant digital wallet to the customer payment vehicle.

23. The method according to claim 22 wherein the merchant billing machine generates and transmits an updated receipt to the customer mobile device.

24. A merchant billing machine configured to generate transaction data comprising a transaction cost and to communicate said transaction data and identification of a merchant digital wallet to a customer digital wallet and/or customer mobile device.

25. The billing machine according to claim 24 comprising a communication device configured to transmit said transaction data and identification of the merchant digital wallet to the customer digital wallet and/or customer mobile device.

26. The billing machine according to claim 25 configured to transmit said transaction data and identification of the merchant digital wallet to a server for communication with the customer mobile device.

27. A computerized network for performing payment transactions, the network comprising:
a merchant billing machine configured to generate transaction data comprising a transaction cost and to communicate said transaction data and identification of a merchant digital wallet to a customer digital wallet and/or customer mobile device; and
a digital wallet server operative to receive transaction data and merchant digital wallet identification along with details of a customer payment vehicle and to transfer the transaction cost from the customer payment vehicle to the merchant digital wallet.
